(19) United States
(12) Patent Application Publication
(10) Pub. No.: US 2008/0085437 A1
(43) Pub. Date: Apr. 10, 2008

(54) Pleated heat and humidity exchanger with flow field elements

(76) Inventors: James Franklin Dean, West Vancouver (CA); Chad Everett Comeault, Vancouver (CA); David Kadylak, Vancouver (CA); Greg Montie, Surrey (CA)

Correspondence Address: CLARK & BRODY, 1090 VERMONT AVENUE, NW, SUITE 250, WASHINGTON, DC, 20005, US

(21) Appl. No.: 11/905,190

(22) Filed: Sep. 28, 2007

Related U.S. Application Data
(60) Provisional application No. 60/847,937, filed on Sep. 29, 2006.
(60) Provisional application No. 60/929,937, filed on Jul. 18, 2007.

(51) Int. Cl. H01M 8/04; B01F 3/04

(52) U.S. Cl. 429/26; 261/104

(57) ABSTRACT

A heat and humidity exchanger comprises a pleated membrane cartridge disposed in a housing. The cartridge comprises a pleated water-permeable membrane via which heat and humidity can be transferred between two fluid streams. A flow field element is disposed within some or all of the folds of the pleated membrane, for directing the stream over the inner surfaces of the folds. The flow field path defined by the flow field element enhances flow distribution across one or both membrane surfaces, controlling the relative flow paths of the two streams on opposite sides of the membrane and reducing the pressure drop across the heat and humidity exchanger. The flow field elements provide improved water transfer and allow for a more compact device. The flow field elements can also assist in supporting the pleated membrane and controlling the pleat spacing within the pleated membrane cartridge. The heat and humidity exchanger is particularly suitable for fuel cell and energy recovery ventilator (ERV) applications.

### FIELD OF THE INVENTION

The present invention relates to a heat and humidity exchanger. The heat and humidity exchanger includes a cartridge comprising a pleated water-permeable membrane. Flow field elements are disposed within the folds of the pleated membrane to direct the flow of fluid streams across opposing surfaces of the membrane between at least one inlet and outlet on each side. In addition to defining the fluid flow paths within the folds, the flow field elements provide support for the membrane and control the pleat spacing within the cartridge. The flow field elements improve the flow distribution of the fluids across the membrane surfaces, improve the heat and humidity exchange and reduce the pressure drop, therefore allowing the exchanger to be more compact. The heat and humidity exchanger is particularly suitable for fuel cell applications and energy recovery ventilator (ERV) applications.

### BACKGROUND

Heat and humidity exchangers (also sometimes referred to as humidifiers) have been developed for a variety of applications, including building ventilation (HVAC), medical and respiratory applications, gas drying, and more recently for the humidification of fuel cell reactants for electrical power generation. Many such devices involve the use of a water-permeable membrane via which moisture and, provided there is a temperature differential across the membrane, heat is transferred between fluid streams flowing on opposite sides of the membrane.

Planar plate-type heat and humidity exchangers use membrane plates that are constructed of planar, water-permeable membranes (for example, Nafion®, cellulose, polymers or other synthetic membranes) supported with a separator material and/or frame. The plates are typically stacked, sealed and configured to accommodate intake and exhaust streams flowing in either cross-flow or counter-flow configurations between alternate plate pairs, so that humidity (and often heat) is transferred via the membrane. Other types of exchangers such as hollow tube and enthalpy wheel humidifiers typically use high cost materials and are generally less compact than plate-type devices. Hollow tube humidifiers also have the disadvantage of high pressure drop, and enthalpy wheels tend to be unreliable because they have moving parts.

A heat recovery ventilator (HRV) is a mechanical device that incorporates a heat exchanger with a ventilation system for providing controlled ventilation into a building. The heat exchanger heats or cools the incoming fresh air using the exhaust air. Devices that also exchange moisture between the two air streams are generally referred to as Energy Recovery Ventilators (ERVs), sometimes also referred to as Enthalpy Recovery Ventilators. An ERV removes excess humidity from, or adds humidity to, the ventilating air that is being brought into a building. The two primary reasons to install an ERV are energy savings and improving indoor air quality in buildings.

In order for buildings to have good indoor air quality they require an exchange of the stale indoor air with fresh outdoor air. In hot and humid climates, energy is wasted when the cooled air from the building is exhausted. In an ERV the exhaust air can be used to cool the warmer air being brought in from the outside, reducing the need for air conditioning. The energy consumption of air conditioners can also be reduced (for example, by as much as 30-50%) by having an ERV remove water vapor from the incoming air, reducing the load on the system cooling the air. If buildings are too humid, ERVs will lower humidity levels, reducing the likelihood of mould, bacteria, viruses, and fungi which cause sickness, absenteeism and lost productivity. On the other hand, in cold dry climates, energy is wasted when the warm air from the building is exhausted, plus there can be an additional issue of the incoming air stream being too dry. As well as transferring heat from the exhaust air to the incoming air, ERVs can be used to recycle water vapor from the exhaust air stream, raising humidity levels, thereby reducing skin irritation and respiratory symptoms caused by dry air.

Thus, in ERVs heat and humidity is transferred between the exhaust air stream of a building and the intake air stream of that building. ERVs typically comprise an enclosure, pumps or fans to move the air streams, ducting, as well as filters, control electronics and other components. The key component in the ERV which transfers the heat and humidity between the air streams is called the core. The two most common types of ERVs are those based on rotating enthalpy wheel devices and those based on planar membrane plate-type devices, both mentioned above. Enthalpy wheel ERVs (also known as energy wheels) typically have a cylindrical honeycomb core that is coated with desiccant. A motor rotates the cylinder, transferring the heat and humidity between the intake and exhaust air streams that are typically directed in a counter-flow configuration through opposite ends of the core. Generally the size and depth of the wheel, along with its rotation speed, will determine the degree of energy recovery. Planar plate-type ERV cores use layers of static plates that are sealed and configured to accommodate the intake and exhaust streams flowing in either cross-flow or counter-flow configurations between alternate plate pairs.

In fuel cell applications, various approaches have been used to increase the humidity of reactant gas streams supplied to a solid polymer fuel cell, such as a proton-exchange membrane (PEM) fuel cell. For example, some conventional systems humidify a reactant gas stream by flowing the reactant gas stream and liquid water on opposite sides of a water-permeable membrane. Water from the liquid stream is transferred through the membrane, thereby humidifying the reactant gas stream. Such liquid water-to-gas humidifiers are commonly used in solid polymer fuel cell systems in which water is used as a cooling fluid, as the cooling water is a convenient source of water for the humidifier. Other conventional approaches for humidification of fuel cell reactant gas streams include the injection of water vapor or atomized water droplets into the reactant stream, without the use of a membrane-type humidifier. Enthalpy wheels have also been used.

It has been shown that in some cases the reactant gas supply streams for solid polymer fuel cells can be heated and humidified using heat generated by the fuel cell and water vapor from the fuel cell exhaust. For example, the heat and water vapor in the oxidant exhaust stream can be used to heat and humidify an incoming reactant supply stream (typically the oxidant) by flowing the inlet stream and the fuel cell oxidant exhaust stream on opposite sides of a water-permeable membrane in a gas-to-gas humidity exchanger. Such an approach is described in U.S. Pat. Nos. 6,106,964; 6,416,895; and 6,783,878. Different membrane-based humidity exchanger constructions can be used for this application, including jelly roll configurations and tube bundle configurations, as well as the planar membrane plate-type designs mentioned above. In the latter, discrete sheets of water-permeable membrane are sandwiched between pairs of plates. Aligned openings in the stacked plates and membranes form internal fluid manifolds for supplying and exhausting the reactant streams to fluid passages that can be formed in the surfaces of plates to direct and distribute the streams across the respective membrane surface.

A benefit of planar plate-type heat and humidity exchanger designs for fuel cell, ERV and other applications, is that they are readily scaleable as the quantity (as well as the dimensions) of the modular membrane plates can be adjusted for different end-use applications. However, in this type of device there is a large number of joints and edges that need to be sealed. As a result such devices can be labor intensive and expensive to manufacture. Also their durability can be limited, with potential delamination of the membrane from the frame and failure of the seals resulting in leaks and poor performance and cross-over contamination (leakage between streams). In ERV applications existing planar plate-type ERV cores typically do not produce the total enthalpy exchange required and they are typically not durable in cold weather climates.

Another approach to heat and humidity exchanger design is to incorporate a pleated water-permeable material in the exchanger. For example, U.S. Pat. No. 4,040,804 describes a heat and moisture exchanger for exchanging heat and moisture between incoming and outgoing air for room ventilation. The exchanger consists of a pleated sheet of water-permeable paper. Air is directed in one direction along the pleats on one side of the pleated paper, and the return air flows in the opposite direction along the pleats on the other side of the pleated paper. The ends of the pleated cartridge are closed by dipping them in wax or a castable potting compound which adheres to the paper. The pleats are separated or spaced, and air passages between the folds are provided, by adhering grains of sand to the pleated paper.

A humidifying apparatus with a similar pleated design, but this time for fuel cell applications, is described in U.S. Patent Application Publication No. 2007/0007674. The apparatus includes a pleated structure comprising a humidifying membrane with a gas-permeable reinforcing material superimposed on one or both surfaces thereof. The reinforcing material imparts a self-supporting property to the pleated structure and maintains the pleat pitch or separation between the membrane pleats, as well as allowing the introduction of gas into the inner portion of the pleated structure. The reinforcing material is a netted or porous sheet material, for example, a woven or non-woven fabric, or preferably a resin or metal net. Secured to the pleated structure around a periphery thereof is a frame.

A primary advantage of such pleated designs is that the manufacturing is simplified. Established continuous pleating manufacturing processes can be used. This allows pleated membranes to be fabricated at lower cost than the planar membrane plates used in conventional membrane plate-type devices, where each layer has to be assembled from discrete pieces of membrane, a support material and frame, and then the layers assembled and sealed together. The fact that there are fewer seals required reduces the potential for leaks, so pleated membrane heat and humidity exchangers also tend to be less prone to failure.

Although the reinforcing material used in the pleated humidifying apparatus, described in the aforementioned patent application, allows introduction of gas into the inner portion of the pleated structure, it does not provide controlled or directional gas flow distribution over the membrane surface. Furthermore, the fluid flow paths through or across such materials tend to be quite tortuous and turbulent, so the flow can be quite restricted and the pressure drop across the apparatus can be significant.

Performance can be improved, and the required heat and humidity exchanger size can therefore be reduced, by enhancing flow distribution across one or both membrane surfaces, controlling the relative flow paths of the two streams on opposite sides of the membrane and reducing the pressure drop across the exchanger, and/or using a membrane with improved water transport and other properties.

### SUMMARY OF THE INVENTION

In one aspect of the invention, a pleated membrane cartridge comprises a pleated water-permeable membrane having a plurality of folds on each side thereof. At least some of the folds on at least one side of the pleated membrane have a flow field element disposed therein. In preferred embodiments the cartridge also comprises a perimeter seal around the perimeter of the pleated membrane.

In another aspect, a heat and humidity exchanger for transferring heat and moisture between a first fluid stream and a second fluid stream comprises a housing and pleated cartridge enclosed within the housing. The housing has a first inlet port, a first outlet port, a second inlet port and a second outlet port. The pleated cartridge comprises a pleated water-permeable membrane. First flow field elements are disposed in some or all of the folds on one side of the pleated membrane for directing the first fluid stream within the folds, from the first inlet port to the first outlet port. Optionally, second flow field elements are disposed in some or all of the folds on the other side of the pleated membrane for directing the second fluid stream within the folds, from the second inlet port to the second outlet port.

The flow field elements define a plurality of discrete fluid flow channels within the folds of the pleated membrane cartridge. In preferred embodiments the flow field elements are individual discrete structures that are disposed in each of the folds. They can be attached to the membrane or not. The membrane is water-permeable, typically substantially gas impermeable, can be pleated and is suitable for use in fuel cell applications, ERV applications, or the particular end-use application. In addition to more conventional water-permeable membranes, porous membranes that contain one or more hydrophilic additives or coatings can be used.

The heat and humidity exchanger can be used in fuel cell applications. In an embodiment of a solid polymer fuel cell system, the first inlet port is connected to a reactant exhaust port of a solid polymer fuel cell, and the second outlet port is connected to a reactant inlet port of a solid polymer fuel cell. The reactant exhaust port is typically the cathode-side (oxidant) exhaust port and the reactant inlet port is typically the cathode-side (oxidant) inlet port, but either or both ports can be on the (fuel) anode-side. The heat and humidity exchanger can also be used in an energy recovery ventilator (ERV) for transferring heat and humidity between air streams entering and exiting a building.

In another aspect of the invention, a method for transferring humidity between a first fluid stream and a second fluid stream comprises flowing the first and second fluid streams on opposite sides of the pleated membrane cartridge described above. Heat is also transferred between the first and second fluid streams if there is a temperature difference between them. In an embodiment of a fuel cell application, the first fluid stream is a reactant supply stream for fuel cell and the second fluid stream is reactant exhaust stream from a fuel cell. In an embodiment of an ERV application the first fluid stream is an intake air stream for a building and the second fluid stream is an exhaust air stream for a building.

In another aspect of the invention, an ERV core comprises a porous membrane with at least one hydrophilic additive. In a corresponding method for transferring heat and humidity between an intake air stream and an exhaust air stream of a building, the intake and exhaust air streams are directed on opposite sides of the ERV core comprising a porous membrane with at least one hydrophilic additive.

### BRIEF DESCRIPTION OF THE DRAWINGS

FIG. 1 is a simplified isometric view of an embodiment of a heat and humidity exchanger with a pleated membrane cartridge disposed within a housing.

FIG. 2 is an exploded view of a heat and humidity exchanger with a pleated membrane cartridge disposed within a housing.

FIG. 3 is a simplified exploded view of a heat and humidity exchanger with a housing containing a pleated membrane cartridge, in which two fluid streams are directed in U-shaped substantially counter-flow configurations on opposite sides of the pleated membrane cartridge.

FIG. 4 is a simplified exploded view of a heat and humidity exchanger with a housing containing a pleated membrane cartridge, in which one of the streams is directed in a U-shaped flow configuration, with the other stream directed substantially counter-flow but in a linear configuration, on the opposite side of the pleated membrane cartridge.

FIG. 5 shows a partially pleated membrane with a bead of adhesive or sealant along the edge at the top and bottom of the membrane sheet, so that when the membrane is pleated the folds on one side of the membrane are sealed at top and bottom.

FIG. 6 is a plan view of an embodiment of a flow field element that can be inserted into the folds on one or both sides of a pleated membrane cartridge.

FIG. 7 is an isometric view of a pleated membrane with flow field elements inserted into the folds on both sides; two of the flow field elements have been pulled out of the folds for illustration purposes.

FIG. 8 shows a plan view of an embodiment of a flow field element, and a perspective view of a portion of that flow field element to illustrate some of the design features thereof.

FIGS. 9a-c illustrate flow field elements of similar designs but with varying size and numbers of channels.

FIG. 10 illustrates the overlay of the flow paths on opposite sides of the membrane when flow field elements that provide U-shaped flow paths are used on opposite sides of a pleated membrane.

FIG. 11a illustrates an example of a flow field element with an array of linear channels. FIG. 11b illustrates an example of a flow field element that is a channel-less separator. FIG. 11c illustrates a monopolar mesh material.

FIG. 12a illustrates a flow field element that is tapered in a direction that would be oriented parallel to the fold of the pleat in a pleated membrane cartridge. FIG. 12b illustrates a flow field element that is tapered in a direction that would be oriented perpendicular to the fold of the pleat in a pleated membrane cartridge.

FIG. 13 is a simplified schematic diagram illustrating an embodiment of a solid polymer fuel cell system in which an exhaust reactant stream from a fuel cell stack is used to humidify and adjust the temperature of a reactant stream supplied to the stack via a heat and humidity exchanger.

FIG. 14 is a simplified schematic diagram illustrating an embodiment of an ERV for transferring heat and humidity between air streams entering and exiting a building.

### DETAILED DESCRIPTION OF EMBODIMENTS OF THE INVENTION

The present invention relates to a heat and humidity exchanger comprising a pleated membrane cartridge that is enclosed in a housing. The cartridge comprises a pleated water-permeable membrane, sealed around the perimeter, and flow field elements that are disposed within the folds (pleats) on at least one side of the pleated membrane. Folds on the other surface of the water-permeable membrane can also have flow field elements disposed therein. The membrane fold wraps around and generally contacts both faces of the flow field element. When there are flow field elements on both sides of the membrane, the flow field elements are effectively interleaved on opposite sides of the pleated membrane.

The flow field elements are for directing fluid streams across the surface of the membrane that is in contact with the element. The open-channels of the flow field element offer less restriction to fluid flow than the netting or meshes used to support the membrane in existing pleated membrane-type heat and humidity exchangers. They also provide more controlled and uniform distribution of the fluid stream over the membrane surface. This improves heat and humidity transfer and reduces pressure drop allowing the exchanger to be more compact for a given humidification capability. In addition, the flow field elements can provide support for the pleated structure, in particular against differential pressures occurring across the membrane from one side to the other. They also provide a convenient way to control or define the spacing between adjacent pleats, and assist in maintaining a consistent pleat pitch (with little or no bunching of pleats) in the membrane cartridge—this can also result in improved performance and a more compact device.

The present heat and humidity exchanger design, comprising a pleated water-permeable membrane cartridge with flow field elements, is particularly suitable for fuel cell applications where it can be used to humidify a reactant stream supplied to a fuel cell. The drier reactant supply stream is directed across one side of the pleated cartridge and a moist stream is directed across the other side, so that water and typically heat is transferred to the supply stream via the water-permeable membrane. The moist stream can be an exhaust stream from the fuel cell, and is preferably the oxidant exhaust stream.

The present pleated membrane cartridge with flow field elements can also be used as the core in energy recovery ventilators (ERVs) for transferring heat and humidity between air streams entering and exiting a building. This is accomplished by flowing the streams on opposite sides of the pleated membrane cartridge. The membrane allows the heat and moisture to transfer from one stream to the other while substantially preventing the air streams from mixing or crossing over.

The present pleated membrane cartridge with flow field elements can also be used in gas drying applications. Another possible application is removing humidity from a contained area occupied by humans (for example, a military tank) without exchanging gases. The present design may also be useful in other applications where moisture and/or heat need to be transferred between fluid streams without significant gas cross-over occurring.

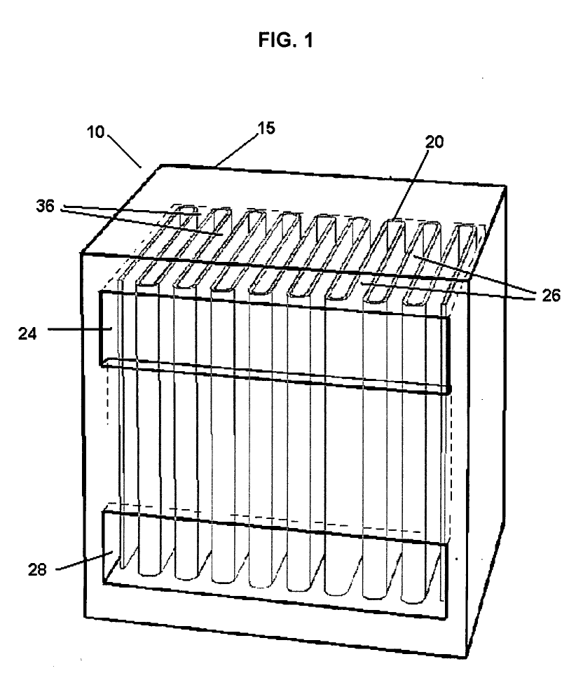

FIG. 1 is a simplified isometric view of an embodiment of a heat and humidity exchanger 10 with a pleated membrane cartridge 20 disposed within a housing 15 (illustrated in outline only, to reveal cartridge 20). The housing has at least one inlet and outlet port (or opening) formed therein for each of the two fluid streams which are directed to flow on opposite sides of cartridge 20. Two such slot-shaped ports, 24 and 28, are shown in FIG. 1.

In embodiments where heat and humidity exchanger 10 is coupled to the cathode side of an operating fuel cell system (not shown in FIG. 1), the hot and humid oxidant exhaust stream enters exchanger 10 via an inlet port, such as port 24, on one side of housing 15. It is then directed into and along the length of the substantially parallel folds 26 on one side of pleated membrane cartridge 20, transferring heat and water vapour across the water-permeable membrane. The stream (now drier and cooler) then exits exchanger 10 via an outlet port, such as port 28. The dry inlet oxidant (air) stream enters heat and humidity exchanger 10 via an inlet port (not shown in FIG. 1) on the opposite side of housing 15. It is then directed into and along the length of the substantially parallel folds 36 on the other side of cartridge 20, picking up heat and water vapour via the membrane. The air, that has been heated and humidified, then exits exchanger 10 via an outlet port (not shown in FIG. 1) and is directed to a fuel cell oxidant inlet port. In the illustrated embodiment the fuel cell oxidant inlet and exhaust streams are directed in a counter-flow configuration relative to one another, in folds 26 and 36 on opposite sides of pleated membrane cartridge 20, although in some cases co-flow or cross-flow configurations may be preferred. The orientation of the cartridge (and the folds formed by the pleats) relative to gravity need not be as shown, although a particular orientation may be preferred in some applications.

Heat and humidity exchanger 10 can also be used in an ERV application for exchanging heat and humidity between air streams being directed into and out of a building (not shown in FIG. 1).

The pleated membrane cartridge can be fabricated using established pleating manufacturing processes. Because the pleating process is typically a continuous process, the pleated elements can be fabricated at lower cost than planar membrane plates.

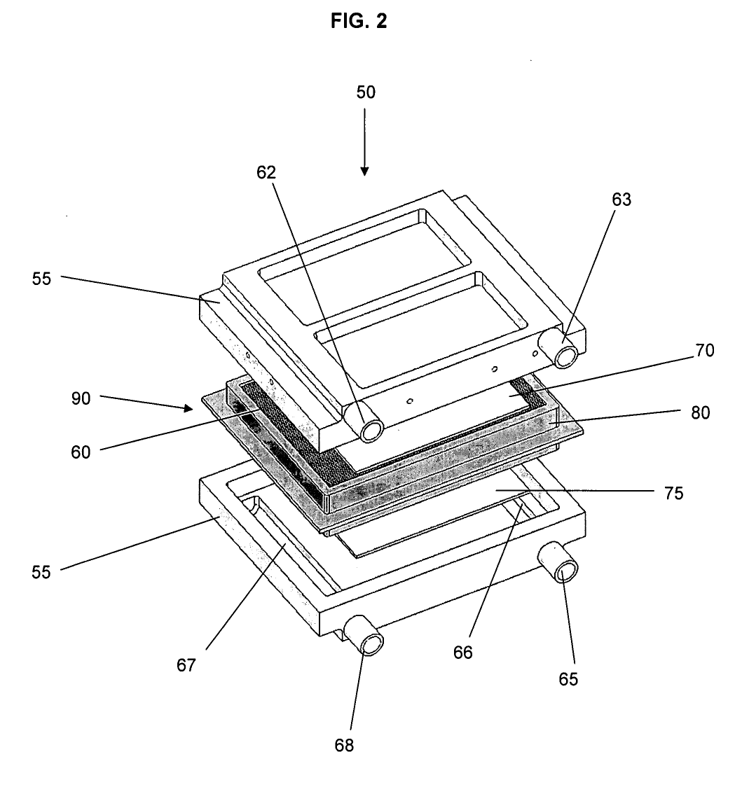

The perimeter of the pleated membrane is sealed to prevent the fluids from leaking between the pleated membrane cartridge and the interior of the housing, and from one side of the cartridge to the other. For example, the cartridge can comprise a gasket or seal disposed around the perimeter of the pleated membrane. Additional gaskets or seals can be disposed against the interior of the housing between the inlet and outlet ports to prevent short-circuiting of the fluids between where the pleated cartridge and the housing meet. Such sealing features are not shown in the simplified illustration of FIG. 1, but examples are illustrated in FIG. 2.

FIG. 2 shows an exploded view of a heat and humidity exchanger 50 comprising a housing 55 (shown in two parts) and a pleated membrane cartridge 90. Housing 55 comprises inlet port 62 which feeds a rectangular header (not visible) on the underside of the upper portion of housing 55, and outlet port 63 which is fed by a similar rectangular header (not visible) also on the underside of the upper portion of housing 55. There is a second pair of ports in fluid communication with the other side of membrane cartridge 90. These are inlet port 65 which feeds a rectangular header 66, and outlet port 68 which is fed by a similar rectangular header 67 formed in housing 55. Flat sheet gaskets 70 and 75 are disposed between each pair of inlet and outlet ports and headers (e.g. 65/66 and 67/68) to prevent short circuiting of the fluids between where pleated membrane cartridge 90 and housing 55 meet (gaskets 70 and 75 can be attached to the interior of housing 55 or can be incorporated into housing 55 or into pleated cartridge 90). Pleated membrane cartridge 90 comprises a pleated water-permeable membrane 60. The perimeter of pleated membrane 60 is “potted” with a sealing material 80 to prevent fluids from leaking between the perimeter of the cartridge 90 and the interior of housing 55. The sealing material holds the pleats in place and provides some rigidity to the cartridge.

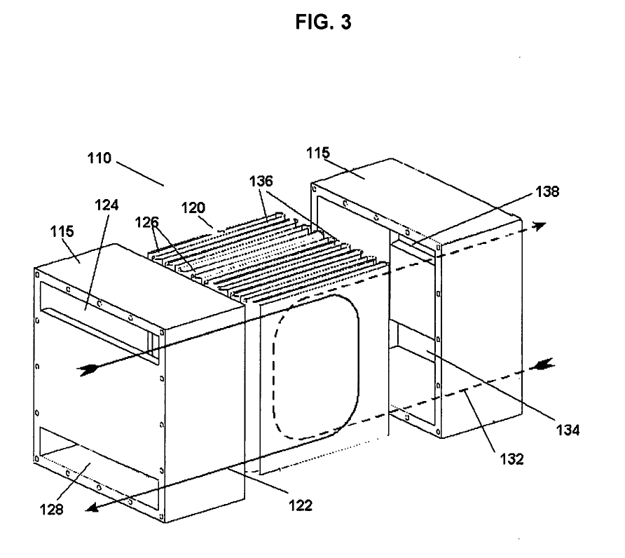

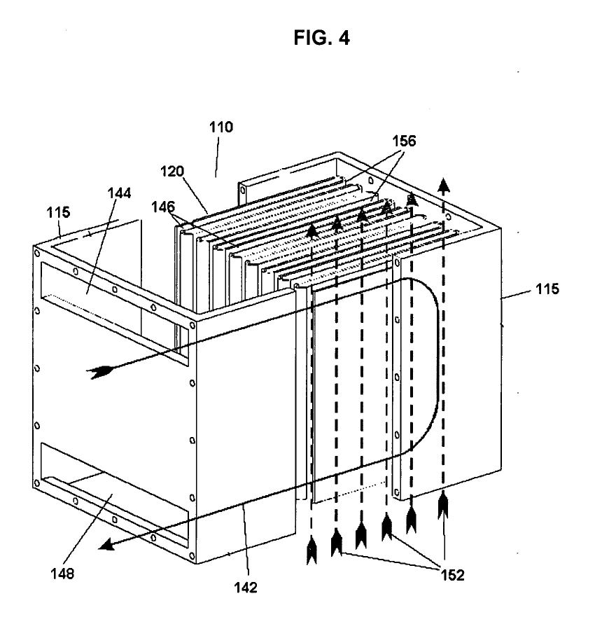

Two possible flow configurations for directing the fluid streams across the pleated membrane cartridge are illustrated in FIGS. 3 and 4, which both show an exploded view of heat and humidity exchanger 110 with a housing 115 (shown in two parts) containing a pleated membrane cartridge 120. Both of these embodiments use a substantially counter-flow regime, which generally provides better heat and humidity transfer compared to a cross-flow or co-flow configuration although the heat and humidity exchanger can use other flow other configurations.

In FIG. 3, a first fluid stream is directed in a U-shaped flow path 122 from an inlet port 124 on one face of housing 115 to an outlet port 128 on the same face of housing 115. The first fluid stream is thus directed from inlet port 124 into a set of substantially parallel folds 126 on one side of pleated membrane cartridge 120, then along the length of the folds 126, and then out via port 128. A second fluid stream is also directed in a substantially U-shaped flow path 132 from an inlet port 134 to an outlet port 138 on the same face of housing 115 (both ports 134 and 138 being on the opposite face of housing 115 from ports 124 and 128). The second fluid stream is directed from port 134 into a corresponding set of substantially parallel folds 136 on the other side of pleated membrane cartridge 120, then along the length of the folds 136, and then out via port 138. The flow path 122 of the first fluid stream is in a substantially counter-flow configuration relative to flow path 132 of the second fluid stream.

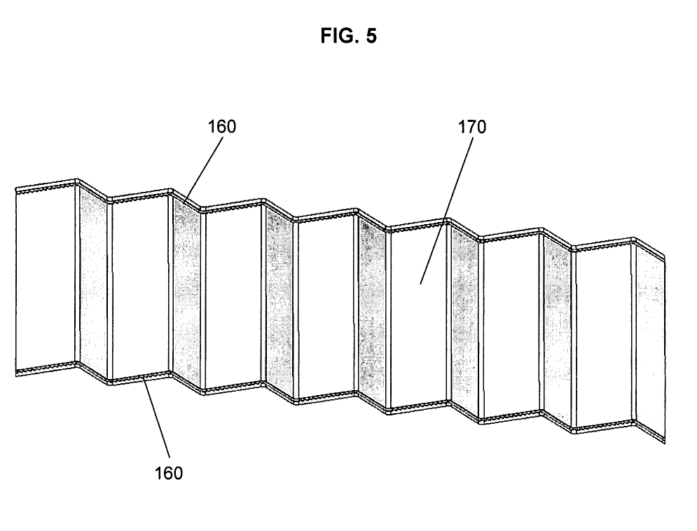

In FIG. 4 the first fluid stream is directed as in FIG. 3 in a U-shaped flow path 142 from an inlet port 144 on one face of housing 115, via folds 146 formed by the pleats on one side of the pleated membrane cartridge 120, to an outlet port 148 on the same face of housing 115. In this embodiment the second fluid stream is directed in a substantially linear flow path 152, between an inlet and an outlet port (not shown) that are on opposite faces of housing 115 and at opposite ends of the substantially parallel folds 156 on the other side of pleated membrane cartridge 120. The U-shaped flow path 142 of the first fluid stream is in a substantially counter-flow configuration relative to the substantially linear flow path 152 of the second fluid stream. While not shown, it should be understood that the both ends of the folds 146 on the top and bottom of the cartridge 120 are blocked so that the second fluid stream of flow path 152 does not mix with the first fluid stream. This could be accomplished, for example as illustrated in FIG. 5, by depositing a bead of adhesive or sealant material 160 on one side of the membrane 170 along the top and bottom edges, so that when it is pleated the folds are bonded together at top and bottom on one side of the pleated membrane but not the other. In this case, when a seal is added to the perimeter of the pleated membrane (e.g. seal 80 in FIG. 2) a window or opening is left in the perimeter seal along both of the pleated edges so that the fluid stream supplied to the linear flow path can be directed in and out of the ends of the folds.

Flow field elements can be disposed within some or all of the folds of the pleated membrane cartridge in any of the embodiments illustrated in FIGS. 1-4 above.

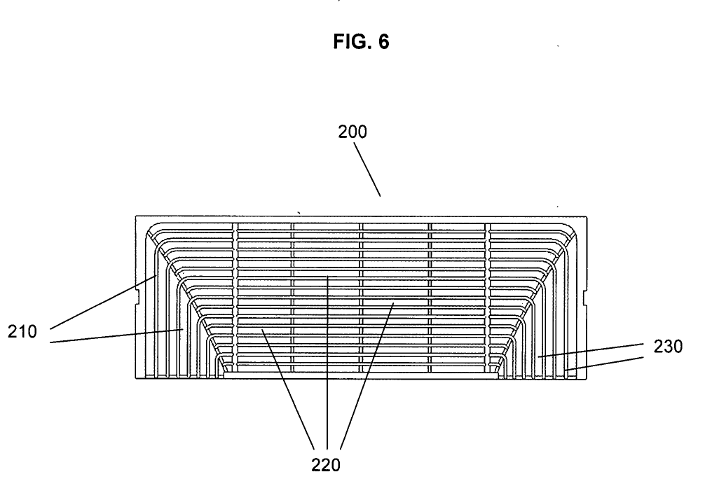

FIG. 6 shows an example of an individual (discrete) flow field element 200 that provides a U-shaped flow path for directing fluid flow into the open side of the fold, along the length of the fold and then back out of the open side of the fold at the other end. In the illustrated embodiment inlet channels 210 enter on one side and at one end of flow field element 200, the channels then turn 90 degrees to direct and distribute the fluid along the length of the fold via an array of parallel linear channels 220, then in a mirrored design, the channels turn back 90 degrees forming outlet channels 230 so that the fluid exits the fold from the same side as it entered it.

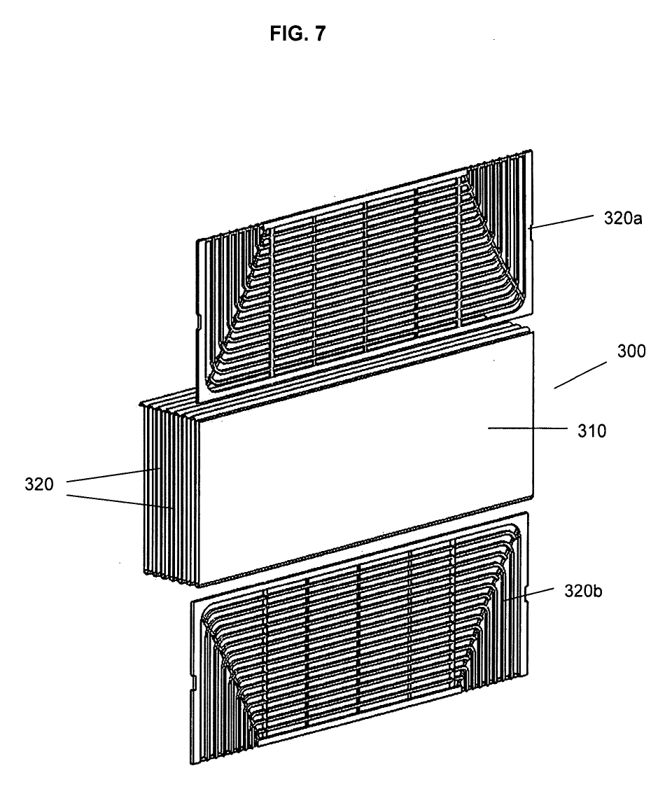

FIG. 7 shows an exploded view of a pleated membrane cartridge 300 comprising a pleated membrane 310 that has flow field elements 320 of the type illustrated in FIG. 6 disposed in the folds on both sides of pleated membrane 310. For illustration purposes, a first flow field element 320a has been pulled out of a pleat on one side of cartridge 300, and a second flow field element 320b has been pulled out of a pleat on the other side of cartridge 300. In this embodiment the two exposed flow field elements are substantially the same, with the fluid streams being directed in a U-shaped flow path by the flow field element within each fold. The flow field elements (for example, 320a and 320b) that are interleaved on opposite sides of pleated membrane 310, are oriented so that the U-shaped flow path of the first fluid stream is in a substantially counter-flow configuration relative to U-shaped flow path of the second fluid stream.

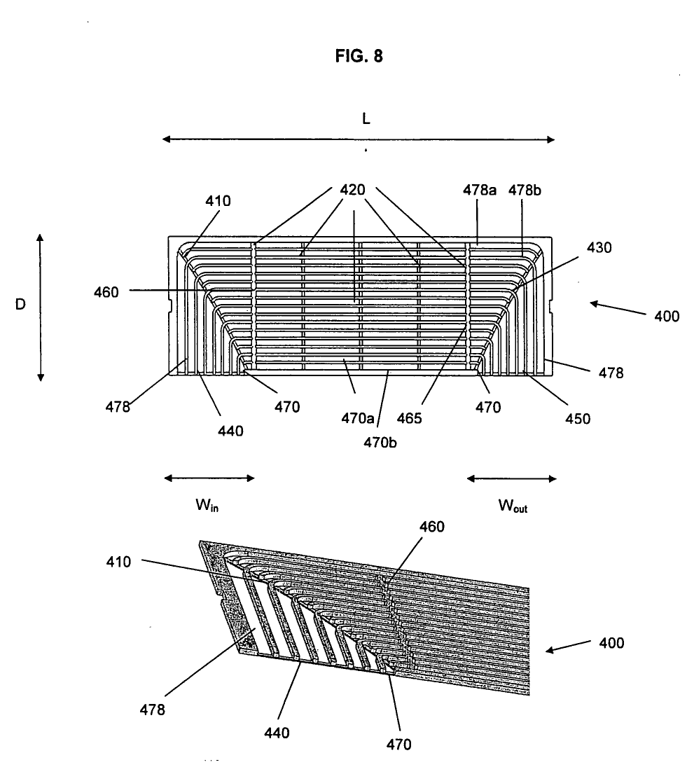

FIG. 8 shows a plan view of an embodiment of a flow field element 400, and a perspective view of a portion of that flow field element to illustrate some of the design features thereof. As can be seen, flow field element 400 is a stencil-like structure with spaced ribs or landings defining discrete channels therebetween. When it is sandwiched between the folds of a pleat, fluid is directed through the channels and is in contact with the membrane on both faces of the flow field element. The open-channels defined by the flow field element (in cooperation with the membrane surfaces) provide much less restriction to fluid flow than conventional membrane support materials, such as meshes or netting. Interconnecting regions 410, 420, 430, 440, 450 can be used to provide structural integrity so that the flow field element is self-supporting and not too delicate to handle. The illustrated design has 5 interconnectors 420 perpendicular to and spanning the main linear channel array; diagonal interconnectors 410 and 430 cross the inlet and outlet regions, and interconnectors 440 and 450 span the inlet and outlet respectively. It is generally desirable to keep these interconnecting regions sufficiently small in area that they do not adversely block fluid access to the surface of the membrane. Also they are shallower in thickness than the remainder of the structure, so that they do not block the flow of fluid through the channels. It is believed, however, that the interconnecting regions may cause some degree of flow separation which can actually enhance heat and humidity transfer. The rigidity of the flow field element and the pleated cartridge is heavily dependant on the material chosen for the flow field element and the thin interconnectors that hold the channel separators (ribs) in place. The spacing and width of the ribs (and corresponding channels in between) can be adjusted depending on factors such as the strength of particular membrane being used, the anticipated differential pressure across the membrane, and the maximum allowable deflection of the membrane.

FIG. 8 reveals some additional optional design features of flow field element 400. The U-shaped flow channel design results in a variation in channel length. It is generally desirable to compensate for this variation, otherwise the fluid will tend to preferentially take the shortest path from inlet to outlet. One or more features that are designed to reduce pressure differences between adjacent channels can be incorporated into flow field element 400. For example, in the illustrated embodiment, pressure compensation gaps 460 and 465 (breaks in the ribs that form the channels), located at the junction between the main linear channel array and the end sections, allow fluid from all channels to mix near the inlet and near the outlet. These gaps tend to equalize the pressure differential from channel-to-channel. This helps to promote uniform flow distribution across the entire flow field element with more uniform channel-to-channel fluid flow distribution throughout the main array. Similarly, the cross-sectional area of the inlet and outlet channels can be varied to encourage uniform channel-to-channel flow distribution. For example as shown, the shortest channel 470 which would normally favour the majority of fluid flow has a smaller cross-sectional area (width in the illustrated embodiment) at the inlet (and/or outlet) than the longest channel 478. This feature can work in conjunction with pressure compensation gaps 460 and 465.

In the embodiment illustrated in FIG. 8, the inlet and exit channel count is half the main array channel count. In other words, each inlet channel is divided into two channels as it makes the 90 degree turn. Similarly at the other end, each pair of linear channels feeds into a single outlet channel. For example, channel 470 is divided into channels 470a and 470b which then feed into a single channel 470 at the outlet. Similarly for channel 478 which splits into channels 478a and 478b in the main linear channel array. This establishes a flow control point at the entrance and exit, while maintaining a reasonable separation between inlet and exit areas. These splitters are preferably located in such a manner to establish a substantially even fluid flow split in both low flow conditions and high flow fluid conditions. Preferably the width of each of the inlet and outlet regions (Wᵢₙ and Wₒᵤₜ) is less than the depth D of the flow field element. Also, preferably the combined width of the inlet and outlet regions (Wᵢₙ+Wₒᵤₜ) is less than the total length L of the flow field element. Preferably the combined width (Wᵢₙ+Wₒᵤₜ) is in the range of 10 to 50% of the total flow field element length (L); for some applications the optimum ratio has been found to be about 35%.

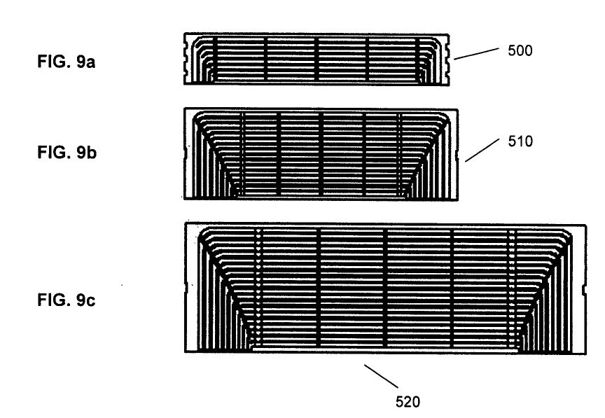

FIGS. 9a-c shows how a flow field element of one basic design can be scaled for different applications. FIG. 9a shows a flow field element 500 with 8 main channels (4 inlet and outlet channels); FIG. 9b shows a flow field element 510 with 16 main channels (8 inlet and outlet channels); FIG. 9c shows a flow field element 520 with 20 main channels (10 inlet and outlet channels). The channel lengths and aspect ratios also vary among the three illustrated flow field elements.

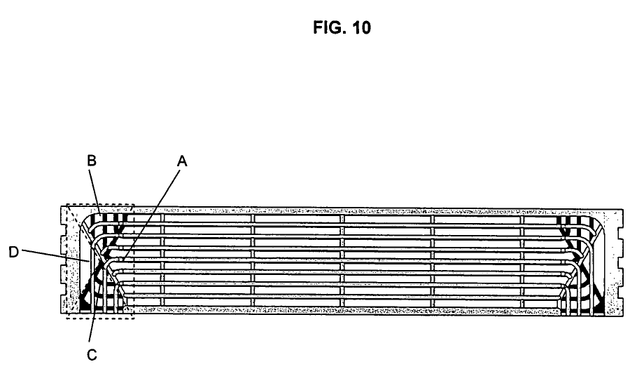

A disadvantage of having flow field elements with a U-shaped flow channel design on both sides of the pleated membrane as shown in FIG. 7, is the end-section flow pattern. The membrane is most effective when operated in a counter-flow configuration. Since the flow field elements are flipped on either side of the membrane, the end sections (outside of the main linear channel array) do not experience full counter-flow regimes. FIG. 10 shows one flow field element overlaid on another. The end sections can be divided into four regions, as shown in FIG. 10, where the main portion is in counter-flow (region A), two smaller portions are in cross-flow (region B and C), and one smaller portion is in co-flow (region D). In cross-flow regions B and C the rib pattern is also criss-crossed on either side of the membrane, providing better structural support, but potentially further reducing the humidifying effectiveness of this region since rib area tends to be less effective for water transport.

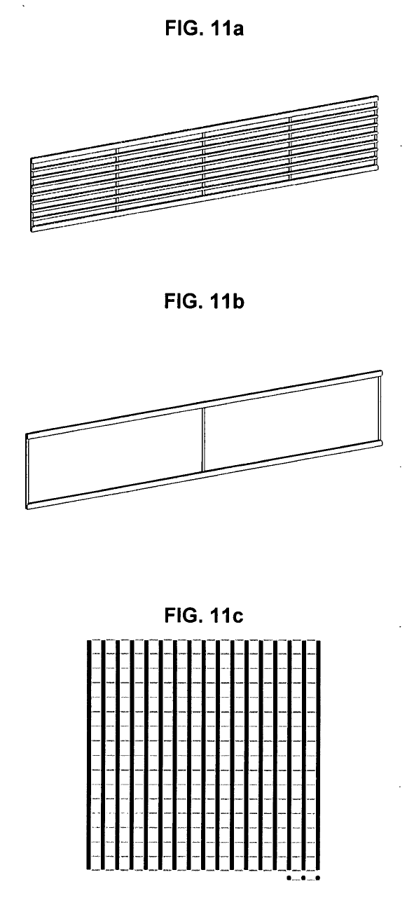

Embodiments with the flow configuration shown in FIG. 4 avoid co-flow regions, even though there is an area of cross-flow near the inlet and outlet. This kind of flow configuration can be accomplished using a flow field element of the type illustrated in FIG. 6 in the folds on just one side of the pleated membrane to provide the U-shaped flow path. The folds could be sealed at top and bottom on that side of the membrane using, for example, the approach described in reference to FIG. 5. A linear flow path is provided on the other side of the pleated membrane with at least one inlet and outlet port provided at opposite ends of the cartridge. For example, flow field elements with an array of linear channels extending parallel to the folds can be used on the other side of the pleated membrane. An example of such a flow field element is illustrated in FIG. 11a. Alternatively a channel-less separator having essentially only a perimeter framework to support the fold could be used to define an open chamber between each of the folds on the other side of the pleated membrane. The fluid could be directed through the chambers in a linear flow path from one end of the fold to the other. Such a channel-less separator would be best used on the higher pressure side of the cartridge otherwise the differential pressure would tend to collapse the chamber and impede the flow path. An example of such a channel-less separator is illustrated in FIG. 11b. Another option would be to use a mesh material on the “linear flow path side” of the membrane. Discrete pieces of mesh could be placed in each fold, or the mesh could be layered or laminated against one side of the entire membrane and pleated with it. Preferably the mesh would preferentially permit fluid flow in a direction parallel to the fold. For example, a monopolar mesh (in which strands of one diameter are oriented at 90° to strands of a different diameter to form a square mesh pattern), such as that illustrated in FIG. 11c could be used. The thicker strands would define the linear flow path parallel to the fold. If a mesh is used on one side of the membrane, particularly if it is pleated with the membrane, the flow field elements used on the other side may not need to provide as much structural support for the membrane.

As will be clear from the foregoing description, a common flow field element design can be used throughout the pleated membrane cartridge (so that the flow field elements used on the wet side of the membrane are the same as those used on the dry side). Alternatively different flow field element designs can be employed within a single cartridge. For example, flow field elements used on one side of the pleated membrane can have a different flow field path or channel pattern than those used on the other side of the pleated membrane. Similarly, flow field elements used on one side of the membrane can be of one thickness, and the flow field elements used on the other side of the membrane can be of a different thickness. Either of these variations from one side of the membrane to the other could allow, for example, for preferential pressure drop compensation for the wet side fluid flow based on viscosity and volumetric flow differences in the wet and dry fluid streams. There could be other differences between the flow field elements used on the wet side and dry side of the membrane. The designs and relative orientation of the separators on opposite sides of the membrane can also be selected to improve the structural support provided to the membrane.

Similarly, even on one side of the membrane different flow field elements can be used in different folds. This approach could be used, for example, to balance flow distribution across the cartridge if there would otherwise be uneven fluid supply to the different pleats from the supply manifold or header.

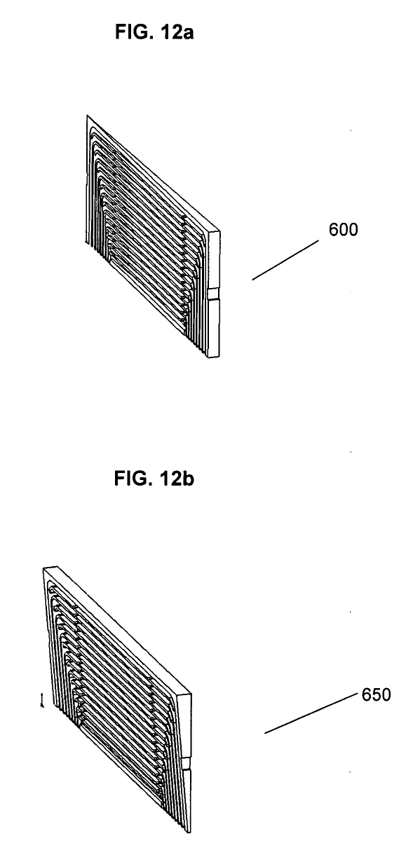

The flow field element is typically a planar structure that is essentially the same thickness across its entire area. However, in some embodiments its thickness can vary. In some such embodiments it is a tapered structure. For example, it can be tapered in the direction that is oriented parallel to the direction of the fold, so that it is thicker in the inlet region and thinner in the outlet region or vice versa. For example, it may be advantageous if the flow field element is thicker (with a correspondingly larger flow channel cross-sectional area) where the stream is wetter, and thinner where the stream is drier. An example of such a tapered flow field element 600 is shown in FIG. 12a. In other tapered embodiments, the flow field element can be tapered in the direction that is oriented perpendicular to the fold, for example so that it is thinner closer to the inside of the fold and wider near the mouth of the fold or vice versa—see for example the tapered flow field element 650 illustrated in FIG. 12b. Such an embodiment could promote more uniform channel-to-channel fluid flow distribution if the shorter channels were the shallower ones located at the thin edge of the tapered element (similar to some of the approaches described in reference to FIG. 8).

The flow field element can be fabricated from a polymer, such as polypropylene, or any other suitable material. The material can be fluid impermeable or porous. Porous materials may allow some fluid access to occur even where the flow field element actually contacts the membrane. The material can be rigid or flexible, but preferably has structural properties that allow the flow field element to provide a desirable degree of membrane support and pleat pitch consistency as described above. The flow field element can be fabricated using a variety of conventional techniques including, but not limited to, injection molding, stamping and possibly extrusion. In some embodiments the flow field elements could be printed or formed directly on one or both sides of the membrane, for example, prior to pleating. This would reduce or eliminate the need for interconnecting regions between ribs, and the flow field element would not need to be able to be a self-supporting (free-standing) structure. Another approach would be to form the flow field element or channel pattern in the membrane material itself so it is integral to the membrane. An example would be an extruded membrane with ribs on at least one side serving as linear flow channels.

In preferred embodiments, the flow field elements are discrete structures that are inserted into individual folds in the pleated membrane. These can be introduced into the folds (on one or both sides of the membrane) during the membrane pleating process or inserted afterwards, either manually or as part of an automated manufacturing or assembly process. They can be bonded or attached to the membrane or not.

In alternative embodiments, multiple flow field elements could be formed in one piece or be joined together. Such multiple flow field elements could be layered or laminated against one or both sides of the unpleated membrane (with or without actual bonding) and pleated along with it, or they could be inserted into a series of adjacent folds after the membrane has been pleated. Again they can be bonded or attached to the membrane or not.

The channel design of the flow field element provides a valuable and convenient way of controlling the flow distribution within the heat and humidity exchanger. The illustrated embodiments show just a few examples of the types of flow field channel designs or patterns that can be used in a flow field element. As with fuel cell reactant flow field plates, a wide variety of channel designs can be used in the heat and humidity exchanger flow field element. For example, the flow field element need not have a symmetrical flow channel pattern. The channels do not have to be predominantly linear channels (although typically these will provide a shorter path and therefore lower pressure drop). The flow field element does not necessarily define a U-shaped flow path for the fluid. The channel width, depth or cross-sectional area can vary along its length. There can be more than one inlet and/or outlet region per flow field element. There are many other possible variations, however the design of the flow field element preferably seeks to enhance heat and humidity exchanger performance (that is affected by flow distribution, pressure drop, and active area access, among other things) while taking into account the desired structural functions of the flow field element (including membrane support, pleat spacing), as well as other factors including manufacturability, cost, and durability.

The design parameters of the pleated membrane component also affect the performance of the heat and humidity exchanger. For example, the pleat geometry and aspect ratio (pleat length, width, pitch, and so forth) affect the performance of the exchanger. These parameters can be adjusted and selected, in combination with the design of the flow field element(s), to give the desired heat and humidity exchanger performance, pressure drop, and exchanger volume, for a particular application.

In combination with careful selection of the pleated membrane and flow field element design parameters mentioned above, operational parameters can also be adjusted and selected to give desirable heat and humidity exchanger performance. The flow field elements described herein allow operational parameters such as residence time and diffusivity of water vapor in the streams in the heat and humidity exchanger to be controlled more readily and accurately than with conventional homogeneous membrane support materials, such as netting or meshes.

In contrast to conventional membrane support materials, flow field elements are engineered components that can be carefully designed to improve heat and humidity exchange across the membrane, and thereby make the humidity exchanger more volume efficient. Nonetheless, they are typically simple to manufacture and incorporate into the pleated membrane heat and humidity exchanger.

Heat and humidity exchangers of the design described herein are particularly suitable as gas-to-gas humidity exchangers, where moisture is transferred from a wetter to a drier gas stream via the water-permeable membrane. However, the heat and humidity exchangers could be used with a liquid stream (for example, liquid water or some kind of aqueous stream) on one or both sides, or with a stream that has two-phase flow. Thus, references to “fluid” herein generally refer to a gas stream, but are also intended to encompass liquid streams, or streams in which there is two-phase flow.

The exchanger housing can be constructed from a hard polymer material (typically a rigid plastic) or from a metal such as aluminium. The housing has at least two inlet ports and at least two exhaust ports. Typically there is a single inlet and outlet port for the wet stream and, and a single inlet and outlet port for the dry stream, although in some embodiments there could be multiple ports for some or all of the streams; for example, there could be additional ports to further reduce the pressure drop across the exchanger.

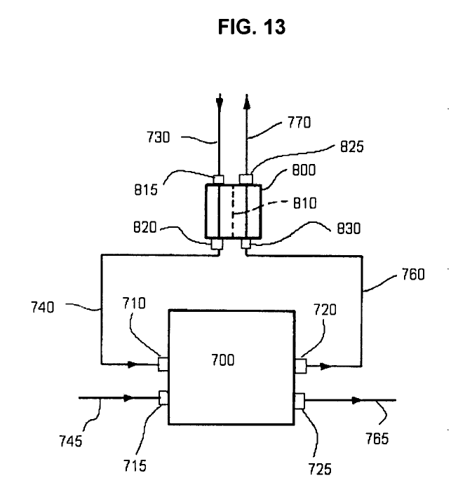

FIG. 13 shows schematically a solid polymer fuel cell stack 700 with a reactant gas stream inlet port 710 and reactant gas stream outlet port 720. The flow path 740 of a humidified reactant stream supplied to fuel cell stack 700 at inlet port 710 is shown schematically, as is the flow path 760 of an exhaust reactant stream exiting the fuel cell stack 700 at port 720. In an operating fuel cell system in which the fuel cell electrochemical reaction is exothermic and produces water, the exhaust reactant stream in flow path 760 will be warmer and have a partial pressure of water vapor higher than the supply reactant stream. The supply reactant stream is directed via flow path 730 and first exchanger inlet port 815 through a heat and humidity exchanger 800, of the type described herein. The fuel cell exhaust reactant stream exiting fuel cell stack 700 at outlet port 720 via flow path 760 is also directed through exchanger 800 via second exchanger inlet port 830, on the opposite side of a water permeable membrane 810, preferably in a counterflow configuration as shown in FIG. 1, whereby heat and water are transferred from the exhaust reactant stream to the supply reactant stream. The humidified reactant stream is then directed from first exchanger outlet port 820 into fuel cell stack 700 at stack inlet port 710 via flow path 730. The fuel cell exhaust stream exits exchanger 800 via second exchanger outlet port 825 and flow path 770, and can be exhausted to the atmosphere or directed elsewhere in the system. Preferably the supply and exhaust reactant streams directed through exchanger 800 are both oxidant streams, in which case the second reactant stream flow path 745 shown entering stack 700 at inlet port 715, and exiting the stack via outlet port 725 and flow path 765 would be the fuel stream. However, the heat and humidity exchanger could be used on the fuel (anode) side as well or instead of on the oxidant (cathode) side. Furthermore, in principle, one reactant exhaust stream could be used to heat and humidify the other reactant supply stream, provided the membrane 810 is substantially impermeable to the fuel and oxidant.

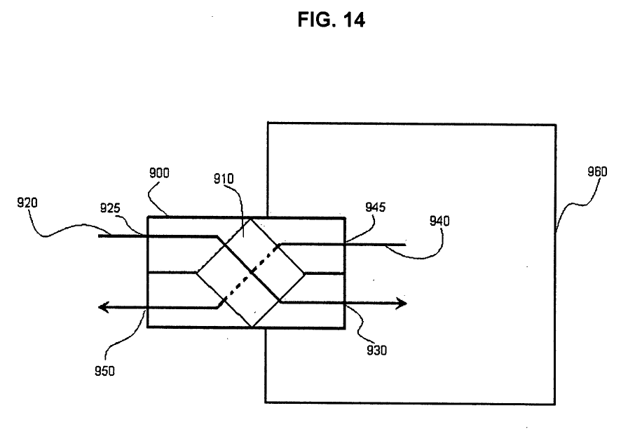

FIG. 14 is a simplified schematic diagram of an ERV 900 for transferring heat and humidity between air streams entering and exiting a building 960. ERVs typically include pumps or fans to move the air streams, ducting, as well as filters, control electronics and other components that are not shown in FIG. 14. Intake air stream 920 enters building 960 from the outside via an air intake port 925. The intake air passes through ERV 900 on one side of a pleated membrane core 910 of the type described herein, and is directed into the building (for example, into the heating and or ventilation system) via port 930. The outgoing air stream 940 from building 960 is directed into ERV 900 via port 945. It passes on the opposite side of the pleated membrane core 910 and exits the building at exhaust port 950. Heat and humidity is transferred across the pleated membrane core 910 between the intake air stream 920 and the exhaust air stream 940. For example, depending on the external environment, the exhaust air from the building can be used to cool and dehumidify warmer air being brought into building, or the exhaust air can be used to heat and humidify the intake air.

The pleated membrane can be any type of a membrane that is water-permeable and suitable for use in fuel cell applications, ERV applications, or the particular end-use application, provided that it can be pleated. In addition to more conventional water-permeable membranes, porous membranes with a thin film coating that substantially blocks gas flow but allows humidity exchange can be used. Also porous membranes that contain one or more hydrophilic additives or coatings can be used as the pleated heat and humidity exchanger membrane. Porous membranes with hydrophilic additives or coatings have desirable properties for use in heat and humidity exchangers generally, and in particular for use in heat and humidity exchangers with a pleated membrane cartridge. Examples of porous membranes with hydrophilic additives include silica-filled polyethylene (PE) from Entek, Duramic or NSG; silica-filled PVC from Amersil; silica-filled PEEK from SiM; and PFSA (perfluorosulfonic acid) coated composite membranes from Fumatech. These types of membranes have favourable heat and humidity transfer properties, are inexpensive, mechanically strong, dimensionally stable, easy to pleat, are bondable to gasket materials such as polyurethane, are resistant to cold climate conditions, and have low permeability to gas cross-over when wet or dry. The ratio of hydrophilic additive to polymer is important. There needs to be enough additive to allow water transfer but also adequate polymer to provide the membrane with strength and durability.

For ERV applications, porous membranes with hydrophilic additives have been found to offer advantages over conventional ERV membrane materials even in conventional membrane plate-type designs. Testing of membrane samples and ERV cores has revealed that porous membranes with hydrophilic additives generally provide better heat and humidity transfer. They are also more durable than desiccant-coated paper-based membranes that are commonly used in ERV applications, particularly when exposed to high levels of condensation (high saturation) and under freeze-thaw conditions.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

What is claimed is:

1. A heat and humidity exchanger for transferring moisture between a first fluid stream and a second fluid stream, the exchanger comprising:
a housing with a first inlet port, a first outlet port, a second inlet port and a second outlet port; and
a pleated cartridge enclosed within the housing, the pleated cartridge comprising:
a pleated water-permeable membrane;
a perimeter seal around the perimeter of the pleated membrane;
a plurality of first flow field elements disposed in folds on one side of the pleated membrane for directing the first fluid stream within the folds, from the first inlet port to the first outlet port.

2. The heat and humidity exchanger of claim 1 wherein the first flow field element defines a plurality of discrete fluid flow channels within the fold.

3. The heat and humidity exchanger of claim 1 wherein the first flow field elements are individual discrete structures.

4. The heat and humidity exchanger of claim 1 wherein the first flow field elements are attached to the one side of the membrane.

5. The heat and humidity exchanger of claim 1 wherein the first flow field elements are injection-molded polymeric structures.

6. The heat and humidity exchanger of claim 1 wherein a first flow field element is disposed in each of the folds on one side of the membrane.

7. The heat and humidity exchanger of claim 1 wherein the membrane is a porous membrane with at least one hydrophilic additive.

8. The heat and humidity exchanger of claim 1 wherein the pleated cartridge further comprises:
a plurality of second flow field elements disposed in folds on the other side of the pleated membrane for directing the second fluid stream within the folds from the second inlet port to the second outlet port.

9. The heat and humidity exchanger of claim 8 wherein the first and second flow field elements are different from one another.

10. The heat and humidity exchanger of claim 8 wherein the first flow field elements define a substantially U-shaped flow path within the folds on one side of the membrane and the second flow field elements define a substantially linear flow path within the folds on the other side of the membrane.

11. The heat and humidity exchanger of claim 1 wherein the first flow field elements are formed on the membrane.

12. The heat and humidity exchanger of claim 1 wherein the membrane is ribbed on at least one side thereof, whereby the first flow field elements are integral to the membrane.

13. A solid polymer fuel cell system comprising the heat and humidity exchanger of claim 1 and a solid polymer fuel cell stack, wherein the first inlet port is connected to a reactant exhaust port of the fuel cell stack, and wherein the second outlet port is connected to a reactant inlet port of the fuel cell stack.

14. An energy recovery ventilator comprising the heat and humidity exchanger of claim 1.

15. A pleated membrane cartridge comprising a pleated water-permeable membrane having a plurality of folds on each side thereof, wherein at least some of the folds on at least one side of the pleated membrane have a flow field element disposed therein.

16. The pleated membrane cartridge of claim 15 wherein the flow field element defines a plurality of discrete fluid flow channels within the fold.

17. The pleated membrane cartridge of claim 15 further comprising a perimeter seal around the perimeter of the pleated membrane.

18. A method for transferring humidity between a first fluid stream and a second fluid stream, the method comprising flowing the first and second fluid streams on opposite sides of a pleated membrane cartridge, wherein the cartridge comprises a pleated water-permeable membrane and a plurality of flow field elements disposed in folds on at least one side of the pleated membrane, the flow field elements defining a plurality of discrete fluid flow channels for directing the fluid streams in contact with the membrane.

19. The method of claim 18 wherein the first fluid stream is a reactant supply stream for fuel cell and the second fluid stream is reactant exhaust stream from a fuel cell.

20. The method of claim 18 wherein the first fluid stream is an intake air stream for a building and the second fluid stream is an exhaust air stream for a building.

21. The method of claim 18 wherein heat is also transferred between the first and second fluid streams.

22. The method of claim 18 wherein the first and second fluid streams flow on opposite sides of the pleated membrane cartridge in a substantially counter-flow configuration.

23. An energy recovery ventilator core comprising a porous membrane with at least one hydrophilic additive.

24. A method for transferring heat and humidity between an intake air stream and an exhaust air stream of a building, the method comprising directing the intake and exhaust air streams on opposite sides of an energy recovery ventilator core, the core comprising a porous membrane with at least one hydrophilic additive.
